(19) United States
(12) Patent Application Publication
(10) Pub. No.: US 2025/0350033 A1
(43) Pub. Date: Nov. 13, 2025

(54) MONOPOLE ANTENNA FOR MOTOR VEHICLES, AND MOTOR VEHILCE COMPRISING SUCH ANTENNA

(71) Applicant: ASK Industries S.p.A., MONTE SAN VITO (IT)

(72) Inventors: Matteo CERRETELLI, SESTO FIORENTINO (IT); Luca FERRARI, SCANDIANO (IT); Andrea NOTARI, SCANDIANO (IT); Fabio CASOLI, REGGIO EMILIA (IT); Stefano SCORCIONI, SERRAMAZZONI (IT)

(21) Appl. No.: 19/196,788

(22) Filed: May 2, 2025

(30) Foreign Application Priority Data
May 7, 2024 (IT) 102024000010255

(51) Int. Cl. H01Q 9/30; H01Q 1/28; H01Q 9/04

(52) U.S. Cl. CPC H01Q 9/30; H01Q 1/282; H01Q 9/0414

(57) ABSTRACT

A monopole antenna for a motor vehicle. The antenna includes a radiating element, a printed circuit board, an electrical contact and a containment enclosure. The radiating element is for transceiving signals with the environment outside the antenna. The electrical contact is configured to electrically connect the radiating element to the printed circuit board. The containment enclosure has at least a first component and a second component that are coupled together and are configured to define one or more internal housing spaces for at least the radiating element and the printed circuit board. The at least one first and second components are connected to each other at least by a waterproof junction.

The present disclosure concerns a monopole antenna for motor vehicles, and to a motor vehicle comprising such an antenna.

The antenna according to the disclosure is especially suitable for use in cars, e.g., mounted on hidden features of a car, such as the metallic bar inside the bumper, and it will be described herein with reference to this use without limiting its possible applications on other types of motor vehicles, such as buses, trucks, commercial vehicles, etc., as well as for installation on other parts of motor vehicles.

As it is known, monopole antennas intended for the installation on a motor vehicle, e.g., on the roof or on any other of its metallic surfaces suitable for its installation, comprise an enclosure which houses a radiating element suitable for transceiving signals and associated electronic components, typically comprising a printed circuit board, which properly processes the signals to be transceived.

Such antennas should satisfy some basic requirements, and in particular they should guarantee the most effective transceiving of signals over time.

To this end, because of their use, these antennas should have a structure which resists atmospheric agents, and in particular which has a substantially tight seal against water infiltrations, and they should offer a proper and lasting connection between functional and/or structural parts, e.g., between the radiating element and the associated printed circuit board, or between one of them, or both, and the enclosure.

Moreover, such characteristics should be achieved in the most simple and optimized manner, both in terms of production aspects of the various parts, and, especially, in terms of their assembly and installation.

Although monopole antennas currently on the market allow somehow to meet these requirements, there are some aspects susceptible to improvement, in particular concerning the waterproof seal, and the manner and difficulty with which the various parts can be assembled and operationally connected with each other.

In one aspect, the present disclosure provides a monopole antenna for a motor vehicle, comprising:
a radiating element for transceiving signals with the environment outside the antenna;
a printed circuit board;
an electrical contact configured to electrically connect the radiating element to the printed circuit board;
a containment enclosure comprising at least a first component and a second component that are coupled together and are configured to define one or more internal housing spaces for at least the radiating element and the printed circuit board, wherein said at least one first and second components are connected to each other at least by a waterproof junction.

In another aspect, the present disclosure provides a motor vehicle comprising at least monopole antenna that comprises:
a radiating element for transceiving signals with the environment outside the antenna;
a printed circuit board;
an electrical contact configured to electrically connect the radiating element to the printed circuit board;
a containment enclosure comprising at least a first component and a second component that are coupled together and are configured to define one or more internal housing spaces for at least the radiating element and the printed circuit board, wherein said at least one first and second components are connected to each other at least by a waterproof junction.

Particular embodiments form the subject of dependent claims, the content of which is intended as an integral part of the present description.

Further features and advantages of the disclosure will become clear from the following detailed description, performed by way of non-limiting example, with reference to the attached drawings, in which:

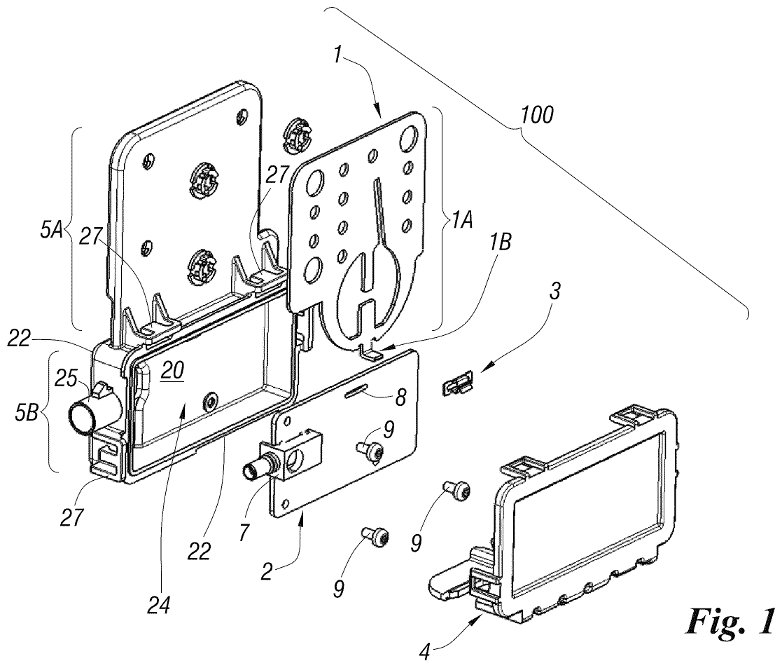

FIG. 1 is an exploded view illustrating a possible embodiment of various components of the monopole antenna according to the disclosure;

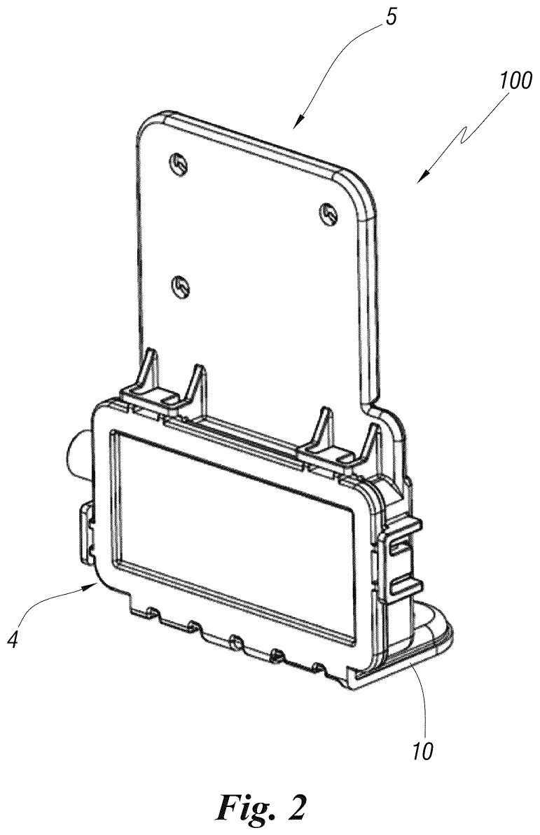

FIG. 2 illustrates the antenna of FIG. 1 with the various components assembled;

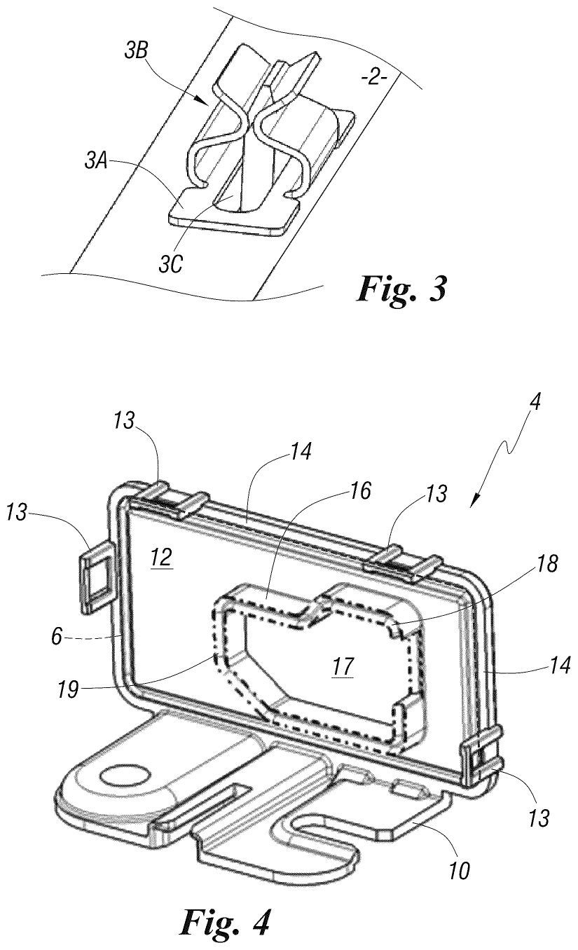

FIG. 3 is a view illustrating a possible embodiment of an electrical contact coupled to a printed circuit board and to a radiating element used in the monopole antenna according to the disclosure;

FIG. 4 is a perspective view illustrating a containment enclosure which is part of the antenna according to the disclosure;

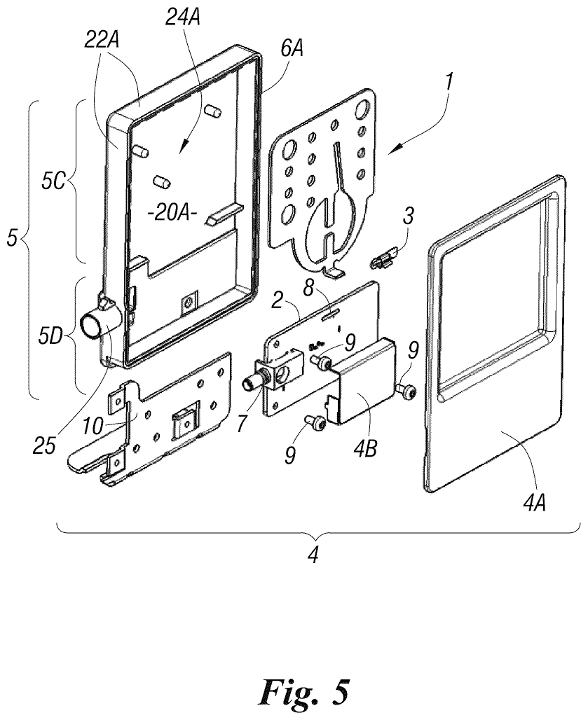

FIG. 5 is an exploded view illustrating another possible embodiment of various components of the monopole antenna according to the disclosure.

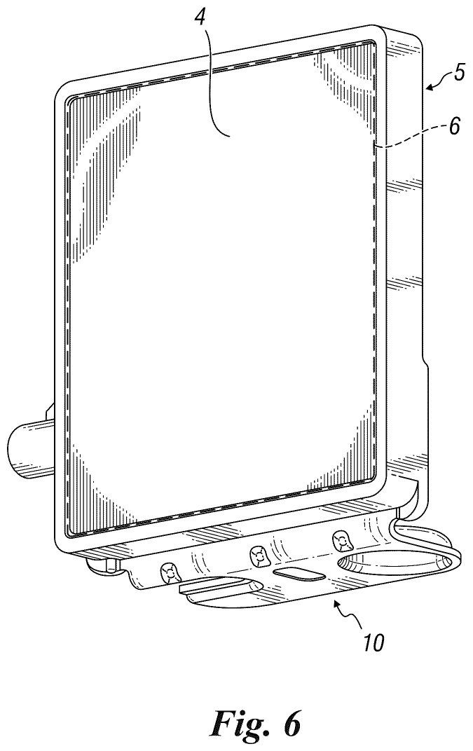

FIG. 6 is a view showing another possible embodiment of the monopole antenna according to the disclosure with the components assembled.

It should be noted that in the following detailed description, identical or similar components, from a structural and/or functional point of view, may have the same or different reference numbers, regardless of whether they are shown in different embodiments or in separate parts in the present disclosure.

It should also be noted that, in order to clearly and concisely describe the present disclosure, the drawings may not be to scale and some features of the description may be showed in a somehow schematic form.

Moreover, when the term “adapted”, or “configured”, or “shaped”, or a similar term is used in the present document, with reference to any component as a whole, or to any part of a component or of a combination of components, it should be intended that it means and correspondingly comprises the structure and/or configuration and/or shape and/or positioning.

In addition, when the term “substantial”, or “substantially” is used herein, it should be intended as comprising a variation due to unavoidable construction tolerances, or a current variation of more or less 5% with respect to what is indicated as reference value, direction or position, and when the terms “transversal” or “transversely” are used herein they should be intended as comprising a direction that is non-parallel to the reference part or parts or to direction(s)/axis to which they refer, and the perpendicularity should be considered a specific case of transversal direction.

Finally, in the following description and claims, the ordinal numbers first, second, etc., will be used for the sake of illustrative clarity and in no way they should be intended as limiting for any reason, nor that the order must exactly be the one in the sequence described with reference to the embodiments described.

For example, the indication of a second portion does not imply that a first one necessarily exists, and vice versa.

FIGS. 1 and 2 illustrate a possible embodiment of an antenna 100 according to the disclosure, showed with its various components disassembled and assembled with each other, respectively.

As illustrated, the antenna 100 comprises at least:
a radiating element 1 for receiving and transmitting (below “transceiving”) signals from and to the environment outside the antenna 100;
a printed circuit board 2 (PCB);
an electrical contact 3 configured to electrically connect the radiating element 1 to the printed circuit board 2, by realizing electrical continuity between the radiating element 1 and the printed circuit board 2; and
a containment enclosure comprising at least a first component 4 and a second component 5 that are coupled together and are configured to define one or more internal housing spaces for at least the radiating element 1 and the printed circuit board 2.

The first component 4 and the second component 5 are connected to each other at least by a waterproof junction, indicated with a dotted line 6 in FIG. 4 and FIG. 6, so as not to substantially allow the penetration of external agents, especially water, in the internal area delimited by the junction 6 itself.

In one possible embodiment, the first and second components 4 and 5 are soldered to each other, i.e. the waterproof junction is constituted by a weld 6.

In another possible embodiment illustrated in FIG. 6, the first component 4 comprises or is constituted by a body made of dielectric resin poured inside and adhered to the second component 5 thereby realizing the waterproof junction along 6. In this embodiment, the second component 5 has for example the same configuration as that depicted in FIG. 5, as it will be described more in details hereinafter.

In practice, the mass of resin forming the body of the first component 4 buries inside the second component 5 the various internal components of the monopole antenna 100, and in particular the radiating element 1, the printed circuit board 2 and the electrical contact 3.

In a possible embodiment, the electrical contact 3 is configured so as to electrically connect the printed circuit board 2 to the radiating element 1 in a structurally removable manner.

In the embodiment showed in FIGS. 1 and 2, the radiating element 1 comprises a body, realized in an electrically conducing material, comprising at least a first portion 1A having a substantially planar development, on which proper drilling and notching are obtained, and a tooth 1B protruding transversely from the first portion 1A, in particular, perpendicular from it.

As it will result more detailed from the following description, the tooth 1B is configured to couple with an associated portion 3B of the electrical contact 3.

The printed circuit board 2 comprises, according to widely known embodiments, a body having a substantially rectangular development, on which one or more electrically conductive tracks are provided.

Along a side of the printed circuit board 2 there is placed a connector 7 which allows connecting an external coaxial cable that delivers the signals (and that typically connects to the radio of the motor vehicle or generally to the Remote Telemetry Control Unit-RTCU, which comprises, for example, GPS, radio, etc.), to one or the principal track present on the printed circuit board 2, which by means of proper active or passive components is then directly connected with the radiating element 1 by means of the electrical contact 3.

Conveniently, the body of the printed circuit board 2 is provided with a pass-through opening 8.

Usefully, as illustrated in FIG. 3, the electrical contact 3 comprises a shaped body, realized in an electrically conductive material, which has a first portion 3A welded to the printed circuit board 2, and a second portion 3B suitable for pressure coupling with an associated portion of the radiating element 1, and in particular with the tooth 1B indicated above.

In particular, in a possible embodiment, the electrical contact comprises a clip or pin shaped body.

For example, as illustrated in FIG. 3, the electrical contact 3 has a base portion 3A, having a substantially planar development, from which two elastic arms protrude from opposite sides to each other.

The two elastic arms have both a lower part which converges with the lower part of the other arm and a second part which diverges from the second part of the other arm and they overall form the portion 3B.

The base portion 3A is provided with a slit 3C.

When the electrical contact is soldered to the printed circuit board 2, the base portion 3A is positioned with the slit 3C overlapping the pass-through opening.

In this way, during the assembly, the tooth 1B of the radiating element 1 is passed through the opening 8 and the fissure 3C, by going into the two arms of the electrical contact 3 which, by elastically reacting, will press the tooth 1B itself between each other.

In this way, the radiating element 1 is electrically connected to the printed circuit board 2, for example at least to one of its conductive tracks.

In one possible embodiment, the monopole antenna 100 comprises a mounting bracket 10, for example made of metallic material, which is part of or associated with the containment enclosure and is configured to allow mounting the antenna 100 to an associated mounting part of the motor vehicle.

In one possible embodiment, as for example illustrated in FIG. 6, the bracket 10 has for example an L-shaped configuration with a first side that is inserted in a portion of and co-molded with the second component 5, and a second side protruding transversally outwardly from the second component 5.

In another possible embodiment, as illustrated in more detail in FIG. 4, the first component 4 of the containment enclosure comprises or is associated to a mounting bracket 10, having for example a shape similar to that of FIG. 6, e.g. L-shaped, a base wall 12, for example extending transversely from the mounting bracket 10, and one of more first side walls 14 extending transversely from the perimeter edge of the base wall 12, e.g., parallel to and towards the mounting bracket 10.

Along the external surfaces of one or more side walls 14, one or more hooking teeth 13 are provided.

For example, according to this embodiment, the first component 4 is realized in an electrically conducing material, e.g., zamak alloy.

In all possible embodiments, as above indicated, the mounting bracket 10 is configured to allow the antenna 100 to be mounted on the motor vehicle, e.g., on the bumper bar or on another metallic surface suitable for the assembly, in a manner known or readily implementable by one skilled in the art, and not relevant for the purpose of the present disclosure anyway, therefore not described in detail herein.

In the embodiment illustrated in FIG. 1-4, the first component 4 of the containment enclosure comprises also an inner wall 16 extending transversely from the base wall 12 parallel to and spaced from one or more side walls 14, e.g., for a height (measured from the base wall 12 itself) higher than the one or more first side walls 14.

In particular, the inner wall 16 laterally delimits, at least in part, an inner space 17 suitable for housing one or more electrical components of the antenna 100.

Usefully, according to this possible embodiment, the printed circuit board 2 is fixed on the upper edge 18 of the inner wall 16 and it is suitable for allowing the bonding of the printed circuit board 2 to the first component 4 of the enclosure itself.

In this way, an electrical continuity between the printed circuit board 2 and the first component 4 is established that provides a grounding and acts as a shielding for the electrical components placed in the inner space 17.

In turn, the second component 5 of the containment enclosure is realized, e.g., in a plastic material, and comprises a first portion 5A having a substantially planar development inside which a portion of the radiating element 1 is placed having at least the tooth 1B protruding from it.

In particular, the radiating element 1 is housed inside the first portion 5A with a predominant part, i.e., more than 50% of its total volume.

In the illustrated embodiment, the second component 5 of the containment enclosure comprises at least a second portion 5B configured substantially in the form of a box open on one side and including a back wall 20, opposite the open side, one or more second side walls 22 which protrude transversely from the back wall around an interior space 24 suitable for housing the printed circuit board 2.

For example, the first portion 5A comprises or consists of a sort of co-molded shell with the radiating element 1, with a lower portion of the radiating element 1 itself, in particular with at least the tooth 1B protruding from the lower part of the first portion 5 protruding inside the space 24.

From a side of the second box portion 5B a channel 25 protrudes which connects the interior space 24 with the external part of the containment enclosure and it is intended to receive the connector 7 from the printed circuit board 2. The channel 25 is properly developed to guarantee the mechanical coupling with an associated connector (not showed in the Figures) which is placed on the motor vehicle wiring and which in turn generates on that side a substantially waterproof joint of the area 24, once it is connected.

Usefully, in one possible embodiment, the waterproof joint 6 comprises or consists of a layer of glue or of sealant that is applied along at least part of one of the top edge of one or more first side walls 14 of the first component 4 and the top edge of one or more second side walls 22 of the second component 5, and is suitable for allowing bonding between said first and second components 4, 5.

In the embodiment illustrated in FIG. 1-4,, the layer of glue 6 is showed as applied along at least part of the top edge of one or more side walls 14 of the first component 4.

Moreover, in a possible embodiment, on the external surface of one or more second side walls 22 one or more hooking sites 27 suitable for receiving each a corresponding hooking tooth 13 are provided so to guarantee the mechanical coupling between the two components 4 and 5, until the sealant/glue is not completely solidified.

Practically, during the assembly step (and in any assembly sequence possible), the printed circuit board 2 is inserted inside the space 24 by tilting it so to make the connector 7 enter inside the guide 25. Once the positioning is complete, the printed circuit board 2 is pressed towards the back wall 20 with the tooth 1B which enters into the opening 8 and goes between the arms of the electrical contact 3 widening them and making contact with the electrical contact 3 itself. The printed circuit board 2 is fixed by screws 9.

The component 4 is then coupled to the component 5.

For example, in the embodiments of FIG. 1-4 the hooking teeth 13 are fitted each into a corresponding hooking site 27; the glue layer, which forms the junction 6, allows the bonding between the two components 4 and 5.

During this step, according to this embodiment, there are also the contact and bonding of the printed circuit 2 on the electrically conductive glue layer 19 which is applied along at least part of the upper edge 18.

FIG. 5 illustrates another possible embodiment of a monopole antenna 100 according to the disclosure, which differs from the embodiment of FIGS. 1-4 basically for what concerns the shape of the two components 4 and 5 and their connection.

In particular, in this embodiment, the first component 4 of the containment enclosure is realized by more separated parts, a first part of which comprises or constitutes the mounting bracket 10, realized in electrically conducing material.

In this embodiment, the first component 4 comprises a cover 4A, e.g., having a substantially planar development, made in plastic material.

For example, the first component 4 may include also a metallic screen 4B.

The metallic screen 4B has a U or C shaping, whether seen from the side, and during the assembly step it is fixed, e.g., welded, to the printed circuit board 2.

In this way, an internal space, similar to the previously described space 17, is defined between the printed circuit board 2 and the central wall of the screen 4B, suitable for housing one or more electronic components of the antenna 100, which are shielded by the screen 4B itself.

In this embodiment (as well as in that of FIG. 6), the second component 5 of the containment enclosure is realized as a whole in the form of a box open on one side, e.g., in plastic material, and comprises a back wall 20A on the opposite side with respect to the open side, from which one or more side walls 22A transversely protrude from the back wall 20A around an internal space 24A suitable for housing the radiating element 1 and the printed circuit board 2.

In particular, the second component 5 comprises:
an upper part 5C at which the portion 1A of the radiating element 1 is positioned and fixed to the back wall 20A, e.g., by crimping, with the tooth 1B transversely protruding towards the inner side of the space 24A; and
a lower part 5D at which the printed circuit board 2 is housed.

Similarly to the embodiment of FIGS. 1-4, a channel 25 protrudes from one side of the lower part 5D connecting the inner space 24A to the external part of the containment enclosure and it is intended to receive the connector 7 of the printed circuit board 2.

In this embodiment, during the assembly step (and in any possible assembly sequence) the radiating element 1 is fixed to the internal face of the back wall 20A at the upper part 5C.

For example, in one embodiment the mounting bracket 10 is co-molded to the second component 5 on the external face of the back wall 20A at the lower part 5D.

The printed circuit board 2 with the metallic screen 4B welded on it is inserted in the lower part of the space 24A by tilting it so to make the connector 7 enter inside the guide 25. Once the positioning is completed, the printed circuit board 2 is pressed towards the back wall 20 with the tooth 1B (the number in the Figure is missing) which enters into the opening 8 and couples with the electrical contact 3. The printed circuit board 2 is fixed by screws 9 directly on the internal face of the component 10, so to guarantee the electrical continuity between the bracket 10 and the printed circuit 2.

The component 4 is then fixed to component 5.

In particular, in this embodiment, the components 4 and 5 are fixed with each other by welding, e.g., by ultrasound welding.

In this case, welding is realized, for example, at the upper edge of one or more side walls 22A, by forming the waterproof junction, indicated in FIG. 5 by the dashed line 6A, similar to the waterproof junction 6 previously described. The electrical continuity and grounding are obtained by the screws 9 which connect the ground copper present on the board 2 with the bracket 10, which will then be electrically connected to the vehicle by a screw that will fasten a buttonhole present on the bracket 10 itself.

As above indicated, in the embodiment of FIG. 6, the second component 5 has substantially the same shape as that of FIG. 5.

In this case, as previously mentioned, the component 4 is formed by a dielectric resin that is applied at the end of the assembling procedure and fills up all the whole internal space defined by the second component 5, with its back wall 20A and the side walls 22A, up to the waterproof junction 6, thereby incorporating all the internal components (e.g., the radiating element 1, the electrical contact 3, the printed circuit board 2 and the internal portion of the bracket 10) in a waterproof structure.

It has been made evident that the antenna 100 according to the disclosure properly achieves the intended purpose as it has a structure which, compared to the known solutions, allows to obtain an optimized assembly, and in which electrical continuity is established between the radiating element 1 and the printed circuit board 2, and between this last one and the component 4 of the enclosure, with at least the junction 6 that guarantees a grip at least with respect to water infiltrations.

Moreover, the antenna 100 presents a structure which makes it suitable for being used either in new motor vehicles or to substitute already installed antennas on motor vehicles in use.

Naturally, given the principle of the disclosure, the embodiments and the particular of the embodiments may be widely varied with respect to what has been described and illustrated by way of non-limiting example, without for this reason stepping out the field of protection of the present disclosure defined by the appended claims, comprising any possible combination, also in part, of the previously described embodiments. For example, in a possible embodiment, the first component 4 can be made of metal or in another electrically conducing material, e.g., a plastic material which is properly charged with electrically conducing particles; in this case fixing the printed circuit board 2 to the inner wall 16 can be realized by substituting the conductive glue with screws which allow to obtain the desired electrical continuity. In the embodiment of FIG. 5, the metallic screen 4B can be omitted.

1. Monopole antenna for a motor vehicle, comprising:
a radiating element for transceiving signals with the environment outside the antenna;
a printed circuit board;
an electrical contact configured to electrically connect the radiating element to the printed circuit board;
a containment enclosure comprising at least a first component and a second component that are coupled together and are configured to define one or more internal housing spaces for at least the radiating element and the printed circuit board, wherein said at least one first and second components are connected to each other at least by a waterproof junction.

2. The monopole antenna according to claim 1, wherein said first and second components are soldered to each other.

3. The monopole antenna according to claim 1, wherein the first component comprises or is constituted by a body made of dielectric resin poured inside and adhered to the second component thereby realizing said waterproof junction.

4. The monopole antenna according to claim 1, wherein said electrical contact comprises a shaped body having a first portion soldered to the printed circuit board and a second portion suitable to couple with an associated portion of the radiating element.

5. The monopole antenna according to claim 1, wherein said electrical contact comprises a body configured to connect the printed circuit board to the radiating element in a structurally removable manner.

6. The monopole antenna according to claim 4, wherein said radiating element comprises a body having at least a first portion having a substantially planar development, and a tooth protruding transversely from the first portion and configured to couple with said second portion of the electrical contact.

7. The monopole antenna according to claim 1, wherein said second component comprises a first portion having a substantially planar development within which is housed at least a portion of the radiating element.

8. The monopole antenna according to claim 1, further comprising a mounting bracket which is part of or associated with the containment enclosure and is configured to allow mounting the monopole antenna to an associated mounting part of the motor vehicle.

9. The monopole antenna according to claim 8, wherein the mounting bracket comprises an L-shaped configuration having a first side that is inserted in a portion of and co-molded with the second component.

10. The monopole antenna according to claim 1, wherein:
said first component of the containment enclosure includes a base wall, and one or more first side walls extending transversely from the perimeter edge of the base wall;
said second component of the containment enclosure includes at least one second portion configured substantially in the form of a box open on one side and including a back wall opposite the open side, one or more second side walls which protrude transversely from the back wall around an interior space suitable for housing said printed circuit board; and wherein said at least one waterproof joint comprises or consists of a weld or of a layer of glue that is obtained respectively applied along at least part of one of the top edge of said one or more first side walls and the top edge of said one or more second side walls and is suitable for allowing bonding between said first and second components.

11. The monopole antenna according to claim 10, wherein said first component of the containment enclosure further comprises an inner wall which extends transversally from the base wall parallel to and spaced apart from one or more of the first side walls, said inner wall laterally delimiting, at least in part, an inner space suitable for housing one or more electronic components of the antenna, and wherein said printed circuit board is attached to the upper edge of the inner wall.

12. The monopole antenna according to claim 11, further comprising a layer of electrically conductive glue which is applied along at least part of said upper edge of the inner wall and is adapted to allow bonding the printed circuit board to the first component of said containment enclosure.

13. The monopole antenna according to claim 1, wherein said first component of the containment enclosure is made at least in part of a metallic material or an electrically conductive plastic material.

14. A motor vehicle, comprising at least one monopole antenna according to claim 1.
